(19) United States
(12) Patent Application Publication
(10) Pub. No.: US 2026/0061632 A1
(43) Pub. Date: Mar. 5, 2026

(54) MAGNET GRIPPER

(71) Applicant: SMC CORPORATION, Tokyo (JP)

(72) Inventor: Hisashi YAJIMA, Tsukubamirai-shi (JP)

(73) Assignee: SMC CORPORATION, Tokyo (JP)

(21) Appl. No.: 19/312,586

(22) Filed: Aug. 28, 2025

(30) Foreign Application Priority Data
Sep. 4, 2024 (JP) 2024-002967 U

(51) Int. Cl. B25J 15/06

(52) U.S. Cl. CPC B25J 15/0608

(57) ABSTRACT

A magnet gripper includes a piston assembly that includes a permanent magnet. An indicator sheet including a print medium in which a photonic crystal is used is attached to a side surface of a cylinder tube.

### CROSS-REFERENCE TO RELATED APPLICATIONS

This application is based upon and claims the benefit of priority from Japanese Utility Model Application No. 2024-002967 filed on Sep. 4, 2024, the contents of which are incorporated herein by reference.

### BACKGROUND OF THE INVENTION

### Field of the Invention

The present invention relates to a magnet gripper capable of indicating the position of a piston.

### Description of the Related Art

Conventionally, there is known a magnet gripper in which a piston to which a permanent magnet is attached is disposed inside a cylinder tube, and the piston is moved to a predetermined position to enable a workpiece to be attracted. Unlike a general cylinder, such a magnet gripper does not include a piston rod, and the piston rod is not exposed to the outside. Therefore, the position of the piston and the generation of the magnetic force cannot be confirmed from the appearance of the magnet gripper.

Magnet grippers capable of detecting the position of the piston are also known. For example, JP 2019-186325 A discloses a magnet gripper in which a piston assembly including a permanent magnet and a core yoke is provided movably inside a cylinder tube, and a magnetic sensor for detecting a magnetic flux of the permanent magnet is attached to a side surface of the cylinder tube.

However, the magnetic sensor must be used by being connected to a power supply and an indicator. In the case where the magnet gripper is unpacked and set up until being attached to the equipment, or in the case where the equipment is stopped, the operator cannot confirm the position of the piston. Therefore, there is a possibility that a magnetic body such as a jig or a tool is erroneously attracted to the magnet gripper, and there is also a possibility that a finger, clothes, or the like of the operator is caught between the magnet gripper and the magnetic body.

### SUMMARY OF THE INVENTION

The present invention has the object of solving the aforementioned problem.

A magnet gripper according to the present invention comprises a piston assembly that includes a permanent magnet, the piston assembly being movably disposed inside a cylinder tube, wherein an indicator sheet including a print medium in which a photonic crystal is used is attached to a side surface of the cylinder tube.

In addition, a magnet gripper according to the present invention comprises a piston assembly that includes a permanent magnet, the piston assembly being movably disposed inside a cylinder tube, wherein a bottom cover is attached to an end portion of the cylinder tube, and an indicator sheet including a print medium in which a photonic crystal is used is attached to an outer surface of the bottom cover.

According to the above-described magnet gripper, since the color of the print medium in which the photonic crystal is used changes according to the magnetic field of the permanent magnet acting on the print medium, the operator can confirm the position of the piston assembly and the presence or absence of the generation of the magnetic force by the change in the color of the indicator sheet.

In the magnet gripper according to the present invention, the indicator sheet including the print medium in which the photonic crystal is used is attached to the side surface of the cylinder tube or the outer surface of the bottom cover. Therefore, in the case where the magnet gripper is unpacked and set up until being attached to the equipment, or even in the case where the equipment is stopped, the operator can easily confirm the position of the piston.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a side view of a magnet gripper according to a first embodiment of the present invention;

FIG. 2 is a cross-sectional view of the magnet gripper of FIG. 1 when a piston assembly is in a suction position;

FIG. 3 is a cross-sectional view of the magnet gripper of FIG. 1 when the piston assembly is in a retracted position;

FIG. 4 is a diagram illustrating an indicator sheet of the magnet gripper of FIG. 1, separated into a print medium and a light shielding sheet;

FIG. 5 is a bottom view of a magnet gripper according to a second embodiment of the present invention; and

FIG. 6 is a diagram illustrating an indicator sheet of the magnet gripper of FIG. 5, separated into a print medium and a light shielding sheet.

### DETAILED DESCRIPTION OF THE INVENTION

Hereinafter, a plurality of preferred embodiments of a magnet gripper according to the present invention will be described with reference to the accompanying drawings. In the following description, when terms in relation to up and down directions are used, for the sake of convenience, such terms refer to the directions shown in the drawings, however, the actual arrangement of the constituent members and the like is not necessarily limited to this feature.

### First Embodiment

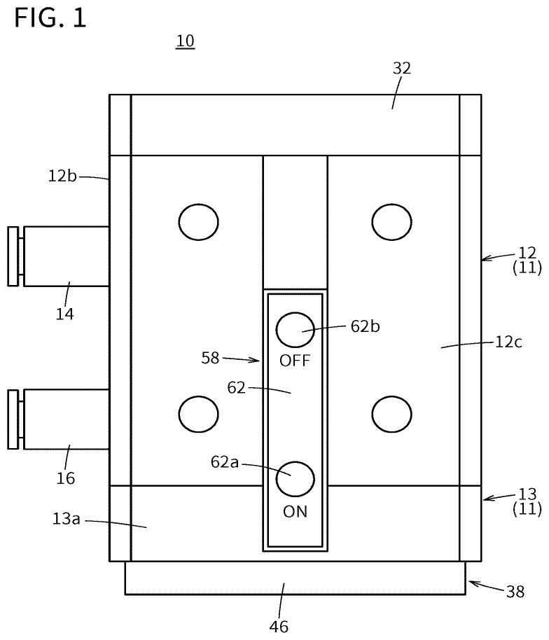

A magnet gripper 10 according to a first embodiment of the present invention will be described with reference to FIGS. 1 to 4. The magnet gripper 10 includes a cylinder tube 11, a piston assembly 18, a top cover 32, a bottom cover 38 and an indicator sheet 58. The cylinder tube 11 includes a cylinder tube body 12 and a connection tube 13, and the cylinder tube body 12 and the connection tube 13 are made of a paramagnetic metal such as an aluminum alloy.

A cylinder hole 12a having a circular cross section is provided in the cylinder tube body 12 so as to penetrate the cylinder tube body 12 in the axial direction thereof. The outer shape of the transverse section of the cylinder tube body 12 is substantially rectangular, and the cylinder tube body 12 includes four side surfaces including a first side surface 12b and a second side surface 12c that are adjacent to each other.

The outer shape of the transverse section of the connection tube 13 is substantially the same rectangular shape as that of the cylinder tube body 12, and the connection tube 13 includes a side surface 13a that matches the second side surface 12c of the cylinder tube body 12. The lower end portion of the cylinder tube body 12 is fitted into the connection tube 13. The lower portion of the connection tube 13 includes an annular flange portion 13b that protrudes inward.

The piston assembly 18 is movably disposed inside the cylinder tube 11. The piston assembly 18 includes a seal holder 20, a core yoke 24, a permanent magnet 28, and a cover yoke 30. The seal holder 20 is formed in a disk shape from a paramagnetic metal such as an aluminum alloy. A piston seal 22, which comes into sliding contact with the wall surface of the cylinder hole 12a, is mounted on the outer periphery of the seal holder 20.

The core yoke 24 is integrally coupled to the seal holder 20 by using a screw member 26. The lower end portion of the core yoke 24 includes a recess 24a having a circular cross section, and a first damper 27 is mounted on the bottom surface of the recess 24a. The permanent magnet 28 having a tubular shape is disposed on the outer periphery of the core yoke 24 having a circular columnar shape, and the cover yoke 30 having a tubular shape is disposed on the outer periphery of the permanent magnet 28. The permanent magnet 28 is magnetized in the radial direction thereof. The core yoke 24 and the cover yoke 30 are made of a steel material which is a ferromagnetic substance.

The upper end of the cylinder tube 11 is closed by the top cover 32. The top cover 32 is formed in a rectangular plate shape from a paramagnetic metal such as an aluminum alloy. A latch yoke 34 is disposed in the lower portion of the top cover 32. The latch yoke 34 is sandwiched and held between the top cover 32 and the cylinder tube body 12. The latch yoke 34 is made of a steel material which is a ferromagnetic substance. The center of the latch yoke 34 includes a through hole 34a capable of receiving the head part of the screw member 26. A third damper 36 is mounted on the inner periphery of the latch yoke 34.

The lower end of the cylinder tube 11 is closed by the bottom cover 38. The bottom cover 38 includes a bottom yoke 40, an outer yoke 42, and a housing 46. The bottom yoke 40 having a circular columnar shape fits into the recess 24a of the core yoke 24 when the piston assembly 18 descends. The outer yoke 42 having a cylindrical shape is disposed outside the bottom yoke 40, and the outer yoke 42 is fixed to the bottom yoke 40 via a coupling plate 48. The bottom yoke 40 and the outer yoke 42 are made of a steel material which is a ferromagnetic substance. A second damper 50 is mounted between the cylinder tube body 12 and the outer yoke 42. The housing 46 is made of a resin material or a rubber material, and is fitted to the outer periphery of the outer yoke 42. The outer shape of the transverse section of the housing 46 is circular.

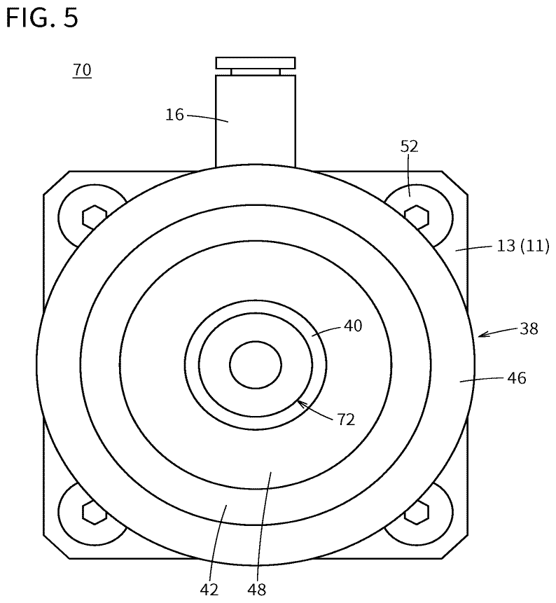

The top cover 32, the cylinder tube body 12, and the connection tube 13 are coupled and fixed together using tie rods 52. Note that the tie rods 52 are shown in FIG. 5 for explaining a second embodiment, which will be described later. The upper portion of the outer yoke 42 includes an annular flange portion 42a that protrudes outward. The flange portion 42a of the outer yoke 42 is sandwiched and held between the lower end of the cylinder tube body 12 and the flange portion 13b of the connection tube 13.

The interior of the cylinder tube 11 is partitioned into a first pressure chamber 54 and a second pressure chamber 56 by the piston assembly 18. The first pressure chamber 54 is formed between the piston assembly 18 and the latch yoke 34. The second pressure chamber 56 is formed between the piston assembly 18 and the bottom cover 38. A first port 14 for supplying and discharging air to and from the first pressure chamber 54 via a passage (not shown), and a second port 16 for supplying and discharging air to and from the second pressure chamber 56 via a passage (not shown), are connected to the first side surface 12b of the cylinder tube body 12.

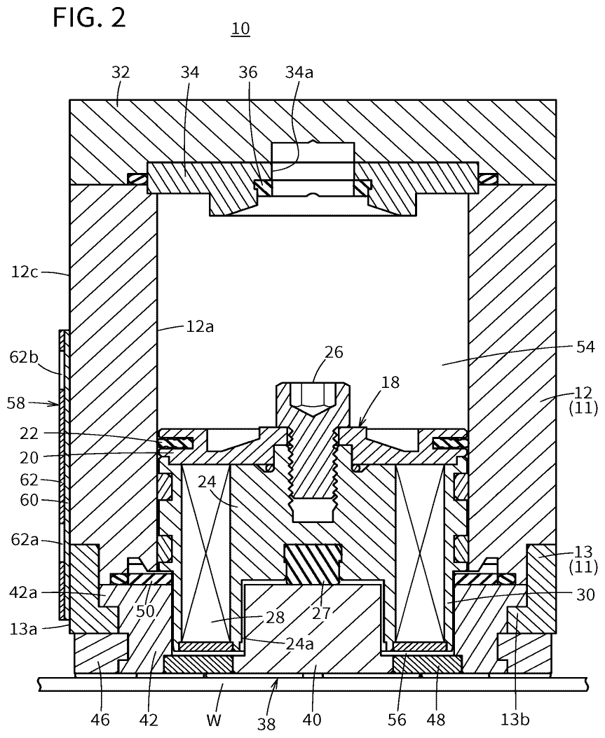

When air is supplied to the first pressure chamber 54 and air in the second pressure chamber 56 is discharged, the piston assembly 18 descends. When the cover yoke 30 of the piston assembly 18 abuts against the second damper 50, and the first damper 27 integrated with the core yoke 24 of the piston assembly 18 abuts against the bottom yoke 40, the piston assembly 18 reaches a suction (attracting) position which is the bottom dead center (see FIG. 2).

When the piston assembly 18 is in the suction position, if a workpiece W such as an iron plate is present below the bottom cover 38, most of the magnetic flux lines that exit the permanent magnet 28 and return to the permanent magnet 28 pass through the core yoke 24, the bottom yoke 40, the workpiece W, the outer yoke 42, and the cover yoke 30. Therefore, the magnetic flux density passing through the workpiece W becomes maximum, and the workpiece W is attracted and held by the magnet gripper 10 with the maximum magnetic attraction force.

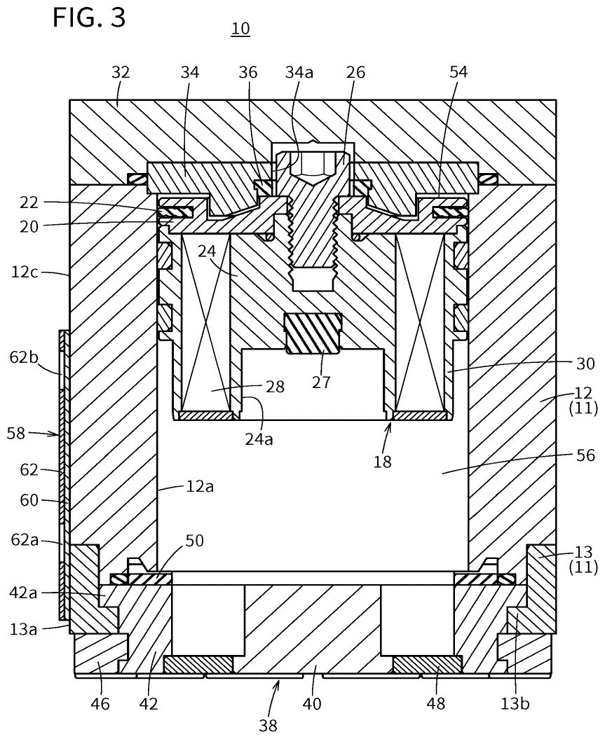

When air is supplied to the second pressure chamber 56 and air in the first pressure chamber 54 is discharged, the piston assembly 18 rises. When the seal holder 20 of the piston assembly 18 abuts against the third damper 36, the piston assembly 18 reaches a retracted position, which is the top dead center (see FIG. 3). When the piston assembly 18 is located near the retracted position, even if a workpiece W such as an iron plate is present below the bottom cover 38, the magnetic attraction force acting on the workpiece W is substantially zero.

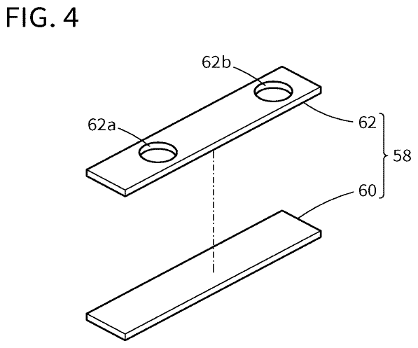

As shown in FIG. 4, the indicator sheet 58 is formed by laminating a print medium 60 in which a photonic crystal is used, and a light shielding sheet 62 including window portions 62a and 62b. The print medium 60 and the light shielding sheet 62 are both strip-shaped members, and the outer shape of the light shielding sheet 62 is substantially the same as the outer shape of the print medium 60. As shown in FIG. 1, the indicator sheet 58 is attached to the second side surface 12c of the cylinder tube body 12 and the side surface 13a of the connection tube 13 by using, for example, an adhesive. The surface of the print medium 60 opposite to the surface overlapping the light shielding sheet 62 is attached to the second side surface 12c of the cylinder tube body 12 and the side surface 13a of the connection tube 13. That is, the light shielding sheet 62 is laminated on the outer side of the print medium 60.

The print medium 60 in which the photonic crystal is used is a known print medium in which a large number of particles having electric charge or magnetism are contained in a dispersed state. When an electric field or a magnetic field is applied to the print medium 60 in which the photonic crystal is used, the distance between the particles changes, and the wavelength of the reflected light changes. The window portion of the light shielding sheet 62 is constituted by the first window portion 62a and the second window portion 62b that are formed by cutting out a part of the light shielding sheet 62 in a round shape.

The first window portion 62a of the light shielding sheet 62 is formed at a position where the magnetic field of the permanent magnet 28 acts most strongly when the piston assembly 18 is in the suction position. When the piston assembly 18 is in the suction position, the light reflected from the print medium 60 and reaching the outside through the first window portion 62a of the light shielding sheet 62 has a bright color such as light green, for example. Therefore, the operator can easily recognize that the piston assembly 18 is in the suction position.

The second window portion 62b of the light shielding sheet 62 is formed at a position where the magnetic field of the permanent magnet 28 acts most strongly when the piston assembly 18 is in the retracted position. When the piston assembly 18 is in the retracted position, the light reflected from the print medium 60 and reaching the outside through the second window portion 62b of the light shielding sheet 62 has a bright color such as light green, for example. Therefore, the operator can easily recognize that the piston assembly 18 is in the retracted position.

The window portion of the light shielding sheet 62 of the present embodiment is constituted by the first window portion 62a for making it possible to visually recognize that the piston assembly 18 is in the suction position, and the second window portion 62b for making it possible to visually recognize that the piston assembly 18 is in the retracted position. However, the window portion of the light shielding sheet 62 may be constituted by only one of the first window portion 62a or the second window portion 62b. In this case, the operator can recognize that the piston assembly 18 is in the suction position or the piston assembly 18 is in the retracted position.

Further, the window portion of the light shielding sheet 62 may be formed between the position where the magnetic field of the permanent magnet 28 acts most strongly when the piston assembly 18 is in the suction position and the position where the magnetic field of the permanent magnet 28 acts most strongly when the piston assembly 18 is in the retracted position. In this case, the operator can recognize that the piston assembly 18 is in an intermediate position between the suction position and the retracted position.

The indicator sheet 58 of the present embodiment is attached across the second side surface 12c of the cylinder tube body 12 and the side surface 13a of the connection tube 13. However, for example, in the case where the window portion of the light shielding sheet 62 is constituted by only one of the first window portion 62a or the second window portion 62b, the indicator sheet 58 may be attached to only one of the second side surface 12c of the cylinder tube body 12 or the side surface 13a of the connection tube 13.

According to the magnet gripper 10 of the present embodiment, the indicator sheet 58 including the print medium 60 in which the photonic crystal is used is attached to the side surface of the cylinder tube 11. Therefore, in the case where the magnet gripper 10 is unpacked and set up until being attached to the equipment, or even in the case where the equipment is stopped, the operator can easily confirm the position of the piston assembly 18 and the presence or absence of the generation of the magnetic force.

### Second Embodiment

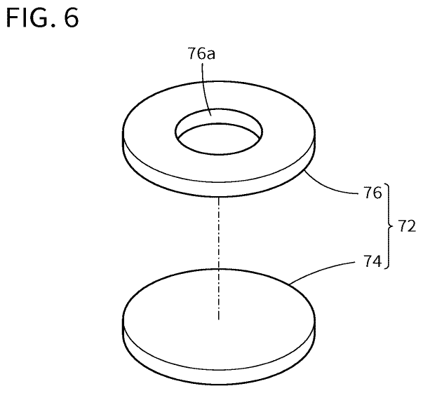

A magnet gripper 70 according to a second embodiment of the present invention will be described with reference to FIGS. 5 and 6. The magnet gripper 70 according to the second embodiment is different from the magnet gripper 10 according to the first embodiment in the shape of the indicator sheet and the position where the indicator sheet is attached. Note that, except for the configuration related to the indicator sheet, the magnet gripper 70 according to the second embodiment has the same configuration as the magnet gripper 10 according to the first embodiment.

As shown in FIG. 6, an indicator sheet 72 is formed by laminating a print medium 74 in which a photonic crystal is used, and a light shielding sheet 76 including a window portion 76a. The print medium 74 and the light shielding sheet 76 are both circular members, and the outer shape of the light shielding sheet 76 is substantially the same as the outer shape of the print medium 74. As shown in FIG. 5, the indicator sheet 72 is attached to the outer surface of the bottom yoke 40 by using, for example, an adhesive. The surface of the print medium 74 opposite to the surface overlapping the light shielding sheet 76 is attached to the outer surface of the bottom yoke 40. That is, the light shielding sheet 76 is laminated on the outer side of the print medium 74. The indicator sheet 72 may be attached to the outer surface of the outer yoke 42.

The print medium 74 in which the photonic crystal is used is a known print medium in which a large number of particles having electric charge or magnetism are contained in a dispersed state. When an electric field or a magnetic field is applied to the print medium 74 in which the photonic crystal is used, the distance between the particles changes, and the wavelength of the reflected light changes. The window portion 76a of the light shielding sheet 76 is formed by cutting out the center of the light shielding sheet 76 in a round shape.

When the piston assembly 18 is in the suction position, the light reflected from the print medium 74 and reaching the outside through the window portion 76a of the light shielding sheet 76 has a bright color such as light green, for example. Therefore, the operator can easily recognize that the piston assembly 18 is in the suction position.

According to the magnet gripper 70 of the present embodiment, the indicator sheet 72 including the print medium 74 in which the photonic crystal is used is attached to the outer surface of the bottom cover 38. Therefore, in the case where the magnet gripper 70 is unpacked and set up until being attached to the equipment, or even in the case where the equipment is stopped, the operator can easily confirm the position of the piston assembly 18 and the presence or absence of the generation of the magnetic force.

The present invention is not limited to the above disclosure, and various modifications are possible without departing from the essence and gist of the present invention.

1. A magnet gripper comprising a piston assembly that includes a permanent magnet, the piston assembly being movably disposed inside a cylinder tube,
wherein an indicator sheet including a print medium in which a photonic crystal is used is attached to a side surface of the cylinder tube.

2. The magnet gripper according to claim 1, wherein
the indicator sheet includes a light shielding sheet including a window portion, and
the light shielding sheet is laminated on an outer side of the print medium.

3. The magnet gripper according to claim 2, wherein
the window portion includes at least one of a first window portion or a second window portion,
the first window portion is formed at a position where a magnetic field of the permanent magnet acts most strongly when the piston assembly is in a suction position, and
the second window portion is formed at a position where the magnetic field of the permanent magnet acts most strongly when the piston assembly is in a retracted position.

4. The magnet gripper according to claim 2, wherein
the window portion is formed between a position where a magnetic field of the permanent magnet acts most strongly when the piston assembly is in a suction position, and a position where the magnetic field of the permanent magnet acts most strongly when the piston assembly is in a retracted position.

5. A magnet gripper comprising a piston assembly that includes a permanent magnet, the piston assembly being movably disposed inside a cylinder tube,
wherein a bottom cover is attached to an end portion of the cylinder tube, and
an indicator sheet including a print medium in which a photonic crystal is used is attached to an outer surface of the bottom cover.

6. The magnet gripper according to claim 5, wherein
the indicator sheet includes a light shielding sheet including a window portion, and
the light shielding sheet is laminated on an outer side of the print medium.
